(19) United States
(12) Patent Application Publication
(10) Pub. No.: US 2014/0325350 A1
(43) Pub. Date: Oct. 30, 2014

(54) TARGET AREA ESTIMATION APPARATUS, METHOD AND PROGRAM

(71) Applicant: KABUSHIKI KAISHA TOSHIBA, Tokyo (JP)

(72) Inventor: Masayuki Okamoto, Kawasaki-shi (JP)

(73) Assignee: KABUSHIKI KAISHA TOSHIBA, Tokyo (JP)

(21) Appl. No.: 14/197,950

(22) Filed: Mar. 5, 2014

(30) Foreign Application Priority Data
Apr. 26, 2013 (JP) 2013-094511

(51) Int. Cl. G06F 17/24; G06F 3/0484; G06F 3/0488

(52) U.S. Cl. CPC G06F 17/24; G06F 3/0488; G06F 3/04842
USPC 715/256

(57) ABSTRACT

According to one embodiment, a target area estimation apparatus includes a first acquisition unit, a second acquisition unit, a conversion unit and an estimation unit. The first acquisition unit is configured to acquire a document formed of a plurality of elements. The second acquisition unit is configured to acquire sampling points of a stroke represented by coordinate values on a screen by obtaining an input of the stroke to the document displayed on the screen. The conversion unit is configured to convert the sampling points into corresponding points each indicating a position in the document or at least one of the elements of the document including the position. The estimation unit is configured to estimate a target area that a user is interested in, based on the corresponding points and the elements.

### CROSS-REFERENCE TO RELATED APPLICATIONS

This application is based upon and claims the benefit of priority from Japanese Patent Application No. 2013-094511, filed Apr. 26, 2013, the entire contents of which are incorporated herein by reference.

### FIELD

Embodiments described herein relate generally to a target area estimation apparatus, method and program.

### BACKGROUND

It has been broadly practiced to input characters to an electronic device by handwriting using a touch pen. Due to the popularization of smart phones, tablet terminals, and portable game devices, as well as personal digital assistants (PDAs), devices having a pen input function have increased in number.

Under these circumstances, a method for a user to designate an area of interest by underlining or circling within a text can be used. This method has a higher degree of freedom than the conventional method of selecting a string of characters by dragging the string from the beginning to the end by using a mouse, and allows a user to designate an area of interest more instinctively.

### BRIEF DESCRIPTION OF THE DRAWINGS

FIG. 1 is an exemplary block diagram illustrating a target area estimation apparatus according to the first embodiment.

FIG. 2 illustrates specific examples of strokes.

FIG. 3 is a table illustrating an example of stroke information.

FIG. 4 illustrates a method of estimating a target area.

FIG. 5 illustrates another method of estimating a target area.

FIG. 6 illustrates an example of detection and estimation operation by the target area estimation unit.

FIG. 7 is an exemplary flowchart illustrating the operation of the target area estimation unit.

FIG. 8 is an exemplary block diagram illustrating a target area estimation apparatus according to the second embodiment.

FIG. 9 illustrates an example of modification processing at the determination unit and the area modification unit.

FIG. 10 illustrates marking examples made to the head of, part of or entirety of a phrase.

FIG. 11 is an exemplary block diagram illustrating a target area estimation apparatus according to the third embodiment.

FIG. 12 illustrates an example of keyword searching at the search unit.

FIG. 13 illustrates an example of displaying documents related to the browsing content.

### DETAILED DESCRIPTION

When a certain area is designated by user's pen strokes or arbitrary movement of a mouse, the designated area is unclear because of the degree of freedom, and it is difficult to correctly specify the designated area.

In general, according to one embodiment, a target area estimation apparatus includes a first acquisition unit, a second acquisition unit, a conversion unit and an estimation unit. The first acquisition unit is configured to acquire a document formed of a plurality of elements. The second acquisition unit is configured to acquire sampling points of a stroke represented by coordinate values on a screen by obtaining an input of the stroke to the document displayed on the screen. The conversion unit is configured to convert the sampling points into corresponding points each indicating a position in the document or at least one of the elements of the document including the position. The estimation unit is configured to estimate a target area that a user is interested in, based on the corresponding points and the elements.

In the following, the target area estimation apparatus, method and program according to the present embodiments will be described in detail with reference to the drawings. In the embodiments described below, elements specified by the same reference number carryout the same operation, and a duplicate description of such elements will be omitted.

### First Embodiment

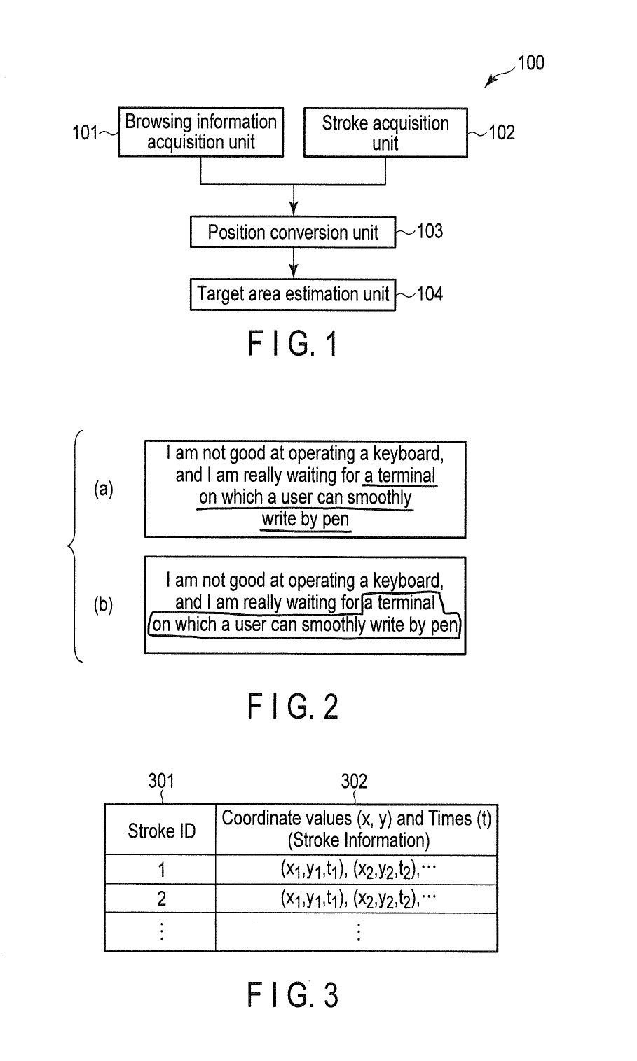

A description of the target area estimation apparatus according to the first embodiment with reference to the block diagram shown in FIG. 1 follows.

The target area estimation apparatus 100 includes a browsing information acquisition unit 101, a stroke acquisition unit 102, a position conversion unit 103 and a target area estimation unit 104.

The browsing information acquisition unit 101 externally acquires a document constructed by a plurality of elements, for example, a structured document. The structured document may be a Hyper Text Markup Language (HTML) document, an Extensible Markup Language (XML) document, an Electronic Publication (EPUB) (registered trademark) document, or a document created by a document composition application. If the structured document is an HTML document, the document has a plurality of HTML elements indicated by tags, each HTML element including a start tag, an end tag and characters (text data) enclosed with the start and end tags. If the structured document is an electronic book, elements may be chapters, sections and paragraphs. In this embodiment, a Web page having the HTML structure will be explained as an example of the structured document browsed by a user. The Web page may include a still picture or a movie in addition to text information.

The stroke acquisition unit 102 acquires a user's stroke by sampling the stroke drawn on the display screen at regular intervals and obtaining sampling points. The stroke acquisition unit 102 also acquires stroke information in which two-dimensional coordinate values of the sampling points on the screen on which the stroke is drawn are associated with the times when the coordinate values are acquired from the sampling points. The stroke information will be described later with reference to FIG. 3.

The stroke drawn by the user may be a handwriting stroke by a touch pen or a finger on the display of a tablet terminal or a smart phone, or a stroke drawn by the user's arbitrary movement of a mouse.

The position conversion unit 103 acquires a structured document from the browsing information acquisition unit 101, and stroke information from the stroke acquisition unit 102. The position conversion unit 103 converts the sampling points into corresponding points based on the coordinate values included in the stroke information. The corresponding points each indicate a position in the structured document or an element in the structured document including the position. The conventional processing for extracting a portion in the structured document which corresponds to an image of a Web page displayed on the screen can be applied to the conversion processing at the position conversion unit 103, and the detailed explanation will be omitted.

The target area estimation unit 104 receives the corresponding points from the position conversion unit 103 and estimates a target area which is an area of interest to the user who has drawn the stroke, in accordance with the relation between the element of the structured document and the corresponding points.

Next, a detailed example of a stroke will be explained with reference to FIG. 2.

The user can designate an area of interest by underlining or circling a string of characters or an area that the user focused on.

For example, as shown in FIG. 2(a), if the user is interested in a phrase “a terminal on which a user can smoothly write by pen,” the user can designate the phrase by underlining it. In addition, as shown in FIG. 2(b), the user can designate the phrase by circling it. An area of interest can be designated by underlining or circling it.

Next, an example of the stroke information acquired at the stroke acquisition unit 102 will be explained with reference to FIG. 3.

The stroke acquisition unit 102 acquires stroke IDs 301 and stroke information 302 including coordinate values and times, which are associated with each other, as shown in the table in FIG. 3.

The stroke IDs 301 each indicate an identification number of a stroke. The stroke information 302 includes two-dimensional coordinate values of sampling points obtained at regular intervals from the beginning of the stroke when a pen or a finger is in contact with the screen to the end of the stroke when the pen or the finger is detached from the screen, and the times when the two-dimensional coordinate values are sampled. That is, each stroke ID 301 indicates an identification number of a single stroke from the beginning to the end.

For example, for stroke ID 301, “1” is associated with stroke information 302 “(x₁, x₁, t₁), (x₂, x₂, t₂), . . . ,” which is stored in a buffer (not shown), for example.

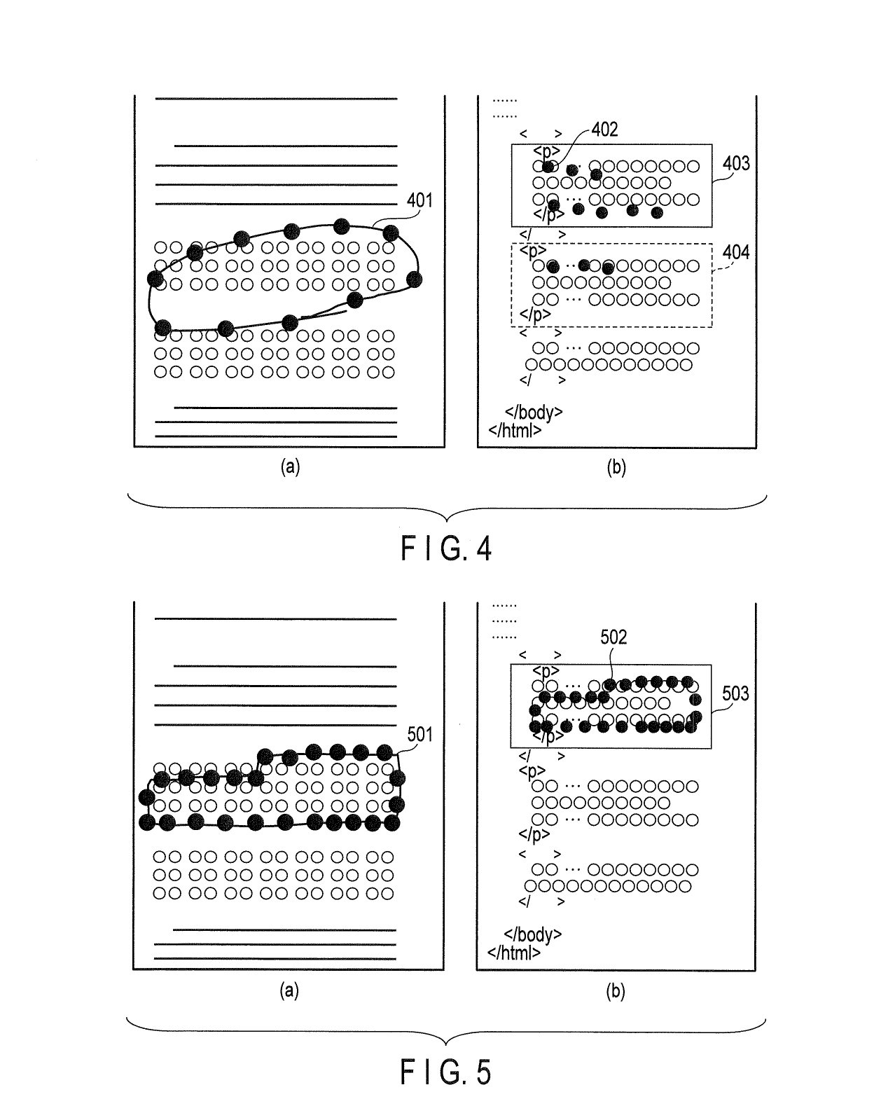

Next, the method for estimating a target area at the target area estimation unit 104 will be explained with reference to FIG. 4.

FIG. 4(a) shows a stroke 401 drawn on a Web page displayed on the screen. The black dots are sampling points which represent points of the stroke. FIG. 4(b) shows corresponding points 402 of the stroke in the HTML structure of the Web page displayed on the screen.

For example, a block area having the largest number of corresponding points 402 included in an element of the structured document is estimated as a target area.

In FIG. 4(b), the number of corresponding points 402 included in HTML element 403 is compared with the number of corresponding points 402 included in HTML element 404. If the number of corresponding points 402 in the element 403 is larger than that in the element 404, the element 403 is estimated as a target area of the user.

Next, another method for estimating a target area at the target area estimation unit 104 will be explained with reference to FIG. 5.

FIG. 5(a) shows a stroke 501 drawn on a Web page displayed on the screen. The black dots are sampling points which represent points of the stroke. FIG. 5(b) shows corresponding points 502 of the stroke in the HTML structure of the Web page displayed in the screen.

As shown in FIG. 5(a), if the stroke was slowly drawn, the sampling points (corresponding points) of the stroke are close to each other. In this case, it is likely that the user marks a small area, for example, only a keyword or a sentence that the user focuses on in comparison with the case where the density of sampling points (corresponding points) of the stroke is low, namely, the case where the user designates an area quickly. Accordingly, in such a case, a string of characters included in the element is estimated as a target area on a character basis.

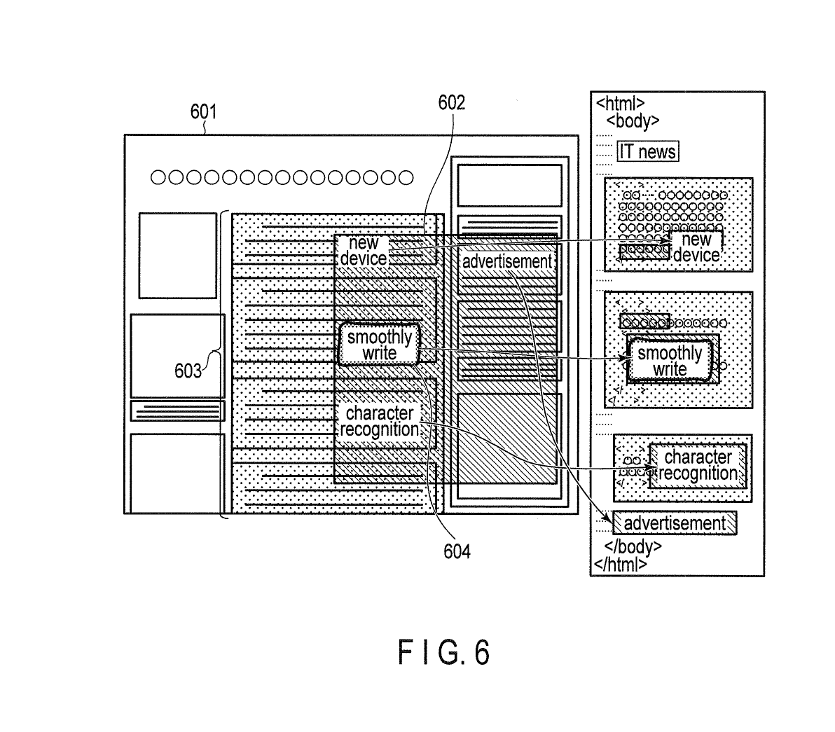

Next, determination of the target area based on the displayed region of HTML element and the structure of HTML source will be explained with reference to FIG. 6.

FIG. 6 shows the relations between an entire web page 601, a displayed region 602 which is a part of the entire web page displayed on the screen, paragraphs 603 part of which is included in the displayed region 602, a target area 604 enclosed by a stroke, and the document (source of the Web page) described by the HTML structure. The user's interest in content of a Web page may be determined depending on whether or not the content is displayed on the screen. This is the first step for estimating a target area. If the user has an interest in a certain area within the displayed region, a stroke may be drawn to the area. This is the second step for estimating a target area.

In the displayed region 602 shown in FIG. 6, at the time when the user has enclosed the phrase “smoothly write” by a stroke of pen, since the term “IT news” is not included in the displayed region 602 or the paragraphs 603, the term “IT news” may not be focused on by the user.

On the other hand, the terms and phrases “new device,” “advertisement,” “character recognition” and “smoothly write” are displayed on the displayed region 602, and they can be a target area. Accordingly, these terms and phrases are accorded a higher priority (first priority) than the terms or phrases, for example, “IT news,” not included in the displayed region 602. Since the phrase “smoothly write” is the target area 604 enclosed by the stroke, the phrase has a higher priority (second priority) than the first priority. The target area may be estimated based on the priority.

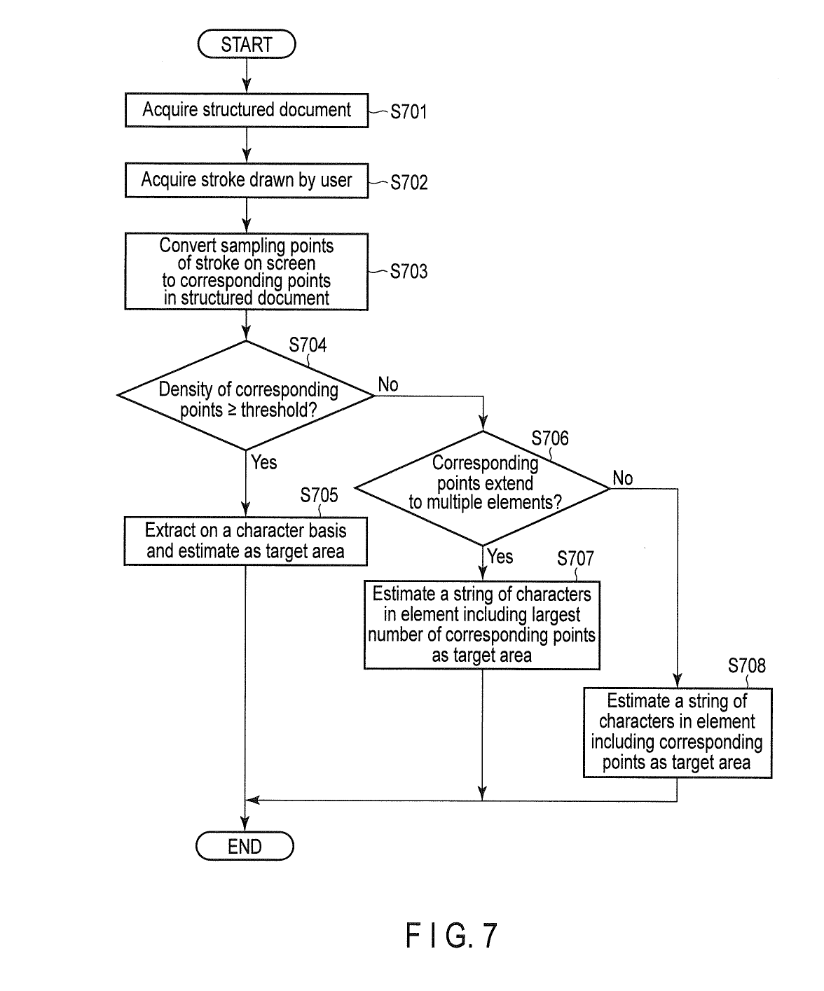

Next, the operation of the target area estimation unit 104 according to the first embodiment will be explained with reference to the flowchart shown in FIG. 7.

In step S701, the browsing information acquisition unit 101 acquires a structured document.

In step S702, the stroke acquisition unit 102 acquires a stroke drawn by the user.

In step S703, the position conversion unit 103 converts sampling points of the stroke on the screen to corresponding points in the structured document.

In step S704, the target area estimation unit 104 determines whether or not the density of corresponding points is not less than a threshold. If the density of corresponding points is not less than the threshold, the step proceeds step S705, If the density of corresponding points is less than the threshold, step S706 is executed.

In step S705, a string of characters in an element of the structured document is extracted on a character basis in accordance with the corresponding points, and the string of characters is estimated as a target area.

In step S706, it is determined whether or not the corresponding points extend to multiple elements. If the corresponding points extend to multiple elements, step S707 is executed, and if not, i.e., the corresponding points exist only in one element, step S708 is executed.

In step S707, a string of characters in an element including the largest number of corresponding points is estimated as a target area.

In step S708, a string of characters in an element including the corresponding points is estimated as a target area. The operation of the target area estimation apparatus according to the first embodiment is completed by the above steps.

According to the first embodiment, the target area that the user focused on is estimated in accordance with the position of the stroke and the density of corresponding points, thereby specifying the selected area while ensuring the degree of freedom in area designation.

### Second Embodiment

The second embodiment is different from the first embodiment in that the target area is modified in accordance with a newly obtained stroke.

There may be a case where the user draws another stroke to modify the target area or delete part of the target area after the target area has been estimated. In such a case, the user can designate an area of interest more flexibly by setting the target area to be modifiable.

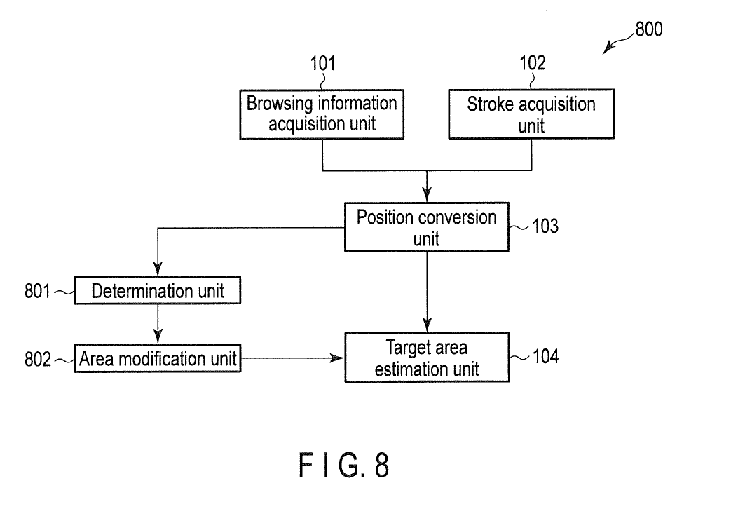

A description of the target area estimation apparatus according to the second embodiment with reference to the block diagram shown in FIG. 8 follows. The target area estimation apparatus 800 according to the second embodiment includes the browsing information acquisition unit 101, the stroke acquisition unit 102, the position conversion unit 103, the target area estimation unit 104, a determination unit 801 and an area modification unit 802.

The browsing information acquisition unit 101, the stroke acquisition unit 102, the position conversion unit 103 and the target area estimation unit 104 carry out the same operations as those of the target area estimation apparatus 100 according to the first embodiment, and the explanations thereof will be omitted.

The determination unit 801 receives the corresponding points from the position conversion unit 103, and determines the processing that the user has performed to the target area. The processing that the user performs to the target area may include addition of another target area, expansion of the target area and deletion of part of or all of the target area. The determination unit 801 determines the process that the user has performed in accordance with the position or density of corresponding points.

The area modification unit 802 receives the determination results from the determination unit 801, and modifies the target area in accordance with the results.

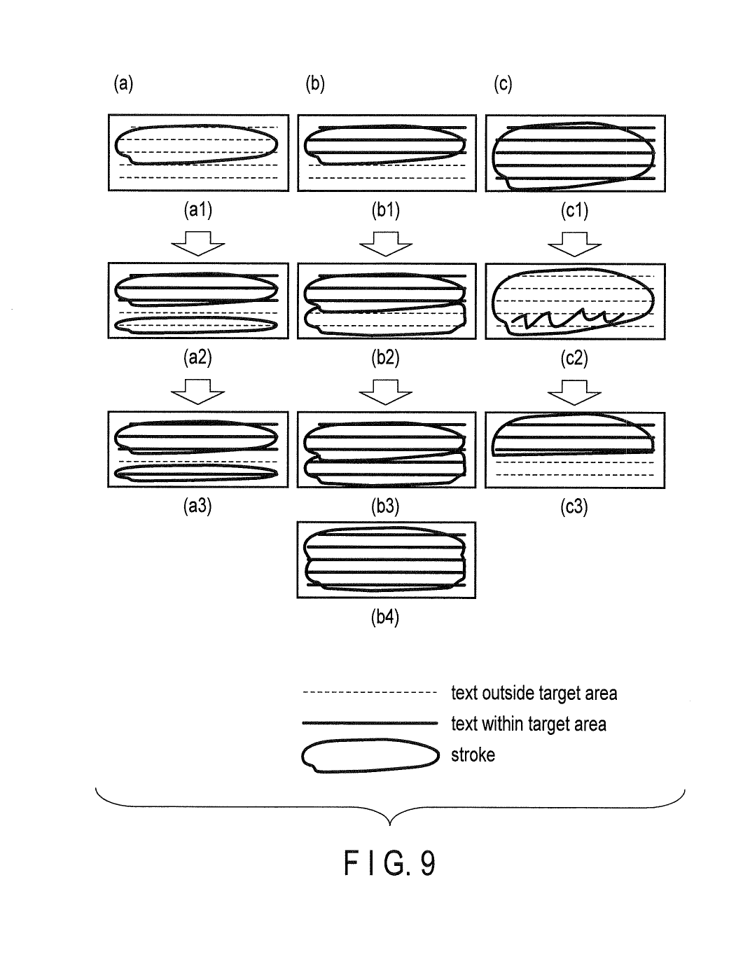

Next, the modification process at the determination unit 801 and the area modification unit 802 will be explained with reference to FIG. 9.

FIG. 9 shows a text displayed on the screen and strokes drawn by the user. The broken lines indicate the text outside the target area, the solid lines indicate the text within the target area, and the handwritten oval lines indicate the strokes.

When a stroke is added, the determination unit 801 determines required processing based on the relation between the target area designated by the existing stroke and an area designated by the added stroke such as the type of added stroke and the area where the stroke has been added.

FIG. 9(a) shows an example that another target area is added independently of the existing target area. FIG. 9(a1) shows the target area that has been estimated. FIG. 9(a2) shows the case where a stroke is added in an area separate from the existing target area. In this case, another target area will be estimated. FIG. 9(a3) shows that another target area has been determined in the same manner as for the case where the first stroke was drawn.

FIG. 9(b) shows an example that the existing target area is expanded. FIG. 9(b1) shows the existing target area that has been estimated. FIG. 9(b2) shows the case where a stroke is added in an area adjacent to the existing target area. The area designated by the added stroke will be added to the target area. An overlap between areas will be determined based on whether the number of corresponding points of the added stroke within the existing stroke is not less than a threshold, or an area indicated by the added stroke overlapping with the existing stroke is not less than a threshold. As shown in FIG. 9(b3), the target area is expanded.

To clarify that the area is expanded, the strokes in the overlapped portion may not be shown, as shown in FIG. 9(b4).

FIG. 9(c) shows an example of reduction of a target area by a stroke indicating deletion. FIG. 9(c1) shows the existing target area. As shown in FIG. 9(c2), if a stroke indicating deletion such as a wavy line is drawn to the existing target area, the target area will be reduced as shown in FIG. 9(c3).

It is determined that a stroke indicates deletion if it has a high density in the corresponding points, for example, filling a narrow area in a short time.

If part of the target area is deleted, the priority of the deleted area may be set as the first priority that is the same as the priority of the displayed region 602 shown in FIG. 6 or set as the same priority as that for an undisplayed area on the screen.

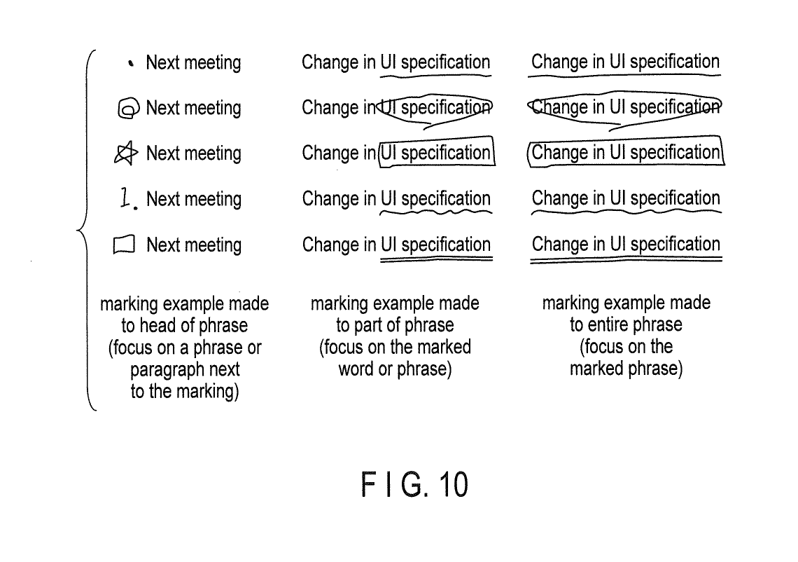

An example of a marking made to the head of, part of or entire phrase will be explained with reference to FIG. 10.

As shown in FIG. 10, if a marking is made to the head of phrase, a marked phrase and a paragraph including the marked phrase will be estimated as a target area.

If a marking is made to part of a phrase, a marked word such as underlined or enclosed word and a phrase including the marked word will be estimated as a target area.

If a marking is made to an entire phrase, a marked phrase such as underlined or enclosed phrase will be estimated as a target area.

According to the second embodiment, the target area may be flexibly estimated by determining the user's intention of adding a stroke.

### Third Embodiment

The third embodiment is different from the first and second embodiments in that a document including the target area is searched based on a keyword. It is possible to provide information according to the user's request by searching for a keyword from the target area marked by the user.

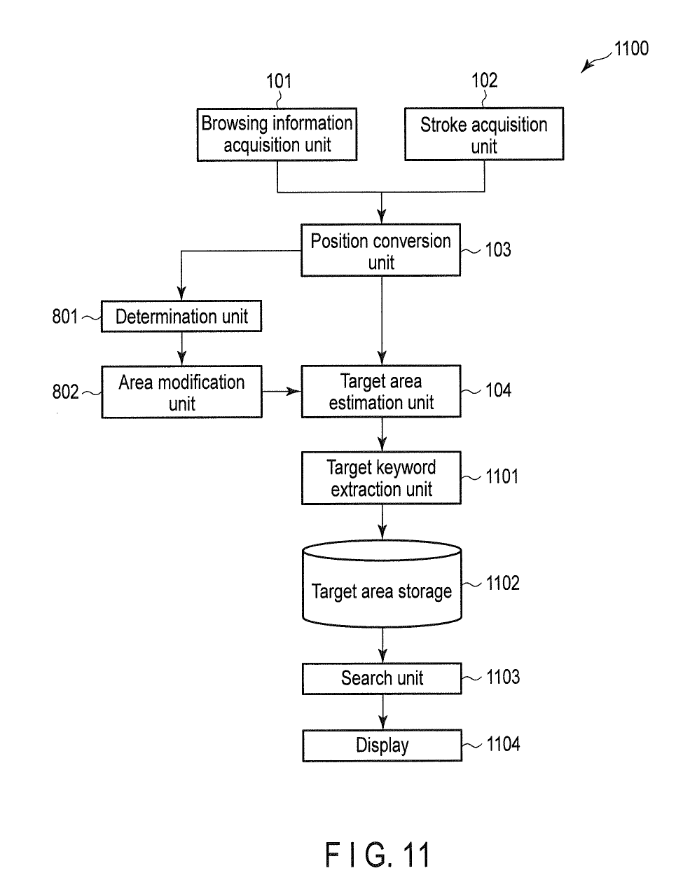

A description of the target area estimation apparatus according to the third embodiment with reference to the block diagram shown in FIG. 11 follows. The target area estimation apparatus 1100 according to the third embodiment includes the browsing information acquisition unit 101, the stroke acquisition unit 102, the position conversion unit 103, the target area estimation unit 104, the determination unit 801, the area modification unit 802, a target keyword extraction unit 1101, a target area storage 1102, a search unit 1103 and a display 1104. In the third embodiment, the target area estimation apparatus 1100 does not have to include the determination unit 801 or the area modification unit 802.

The browsing information acquisition unit 101, the stroke acquisition unit 102, the position conversion unit 103, the target area estimation unit 104, the determination unit 801 and the area modification unit 802 carry out the same operations as those of the target area estimation apparatus 100 according to the second embodiment, and the explanations thereof will be omitted.

The target keyword extraction unit 1101 receives a target area from the target area estimation unit 104 and extracts a keyword from the target area. The keyword may be extracted by using the conventional keyword extraction method such as morphological processing, proper expression extraction processing, or extraction processing by matching with a word in the registered dictionary, and the explanation thereof will be omitted.

The target area storage 1102 receives at least one keyword, one element in the structured document corresponding to the target area and one element in the structured document corresponding to the displayed area from the target keyword extraction unit 1101 and stores them.

The search unit 1103 receives an input of a search word which is a string of characters that the user wishes to search for, searches for a keyword equal to the search word among keywords stored in the target area storage 1102, and obtains the matched keyword and a target area including the keyword as the search result. A displayed area in which the matched keyword is displayed may be obtained as the search result.

The display 1104 receives the search word, the keyword and the target area from the search unit 1103, and displays them in accordance with the priority.

When obtaining the search result, the priority of keyword to be displayed to the user may be determined based on whether the area including the keyword is a target area, a displayed area or an area other than the target area or the displayed area.

For example, in FIG. 6, it can be set that the priority of a keyword in the target area 604 is the highest, the priority of a keyword in the displayed region 602 is the second highest, the priority of a keyword not included in the target area 604 or displayed region 602 but in paragraphs 603 of the Web page part of which is displayed in the displayed region 602 is the third highest, and the priority of a keyword not included in target area 604, displayed region 602 or paragraphs 603 but in the entire page 601 is fourth highest.

The target area estimation apparatus 1100 according to the third embodiment does not need to include the target area storage 1102. In this case, keywords, elements in the structured document corresponding to the target area and elements in the structured document corresponding to the displayed area may be stored in an external storage device.

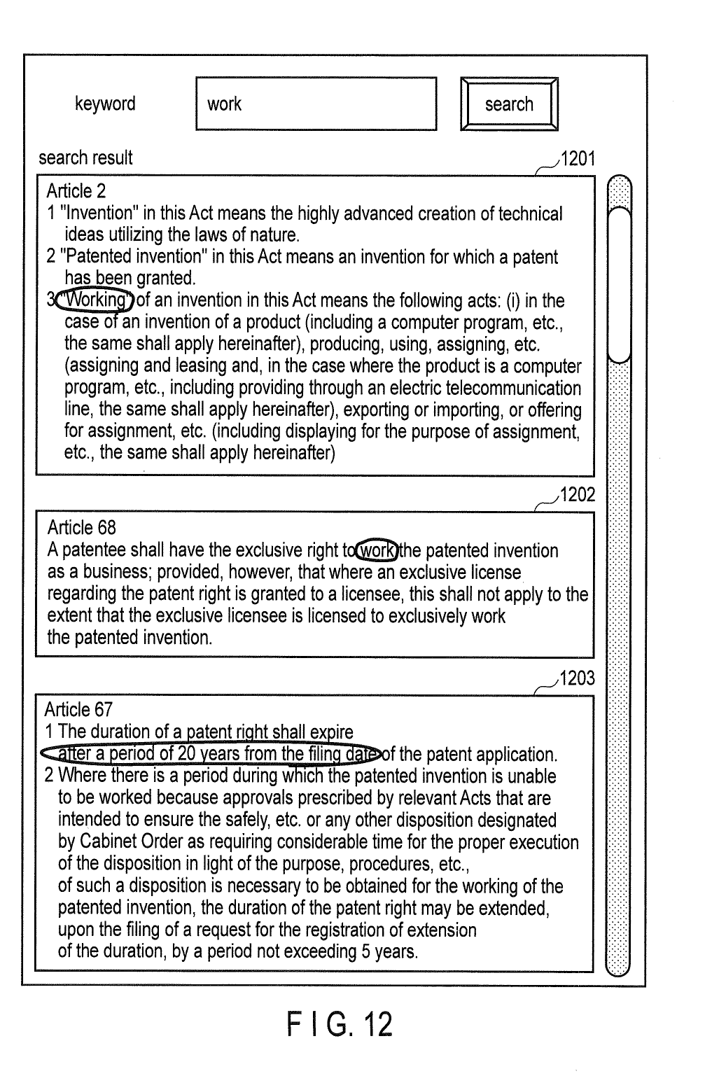

Next, an example of keyword search according to the third embodiment will be explained with reference to FIG. 12.

FIG. 12 shows an example of searching for documents including a target area by a keyword. In this embodiment, searching is performed within an internal storage of a handwriting tablet terminal or external Web pages. FIG. 12 shows an example that a word “work” is searched for. In this case, documents 1201 and 1202 including the target area in which the keyword “work” is marked by the user are displayed as search results with a high priority. In addition, document 1203 including the keyword “work” in the displayed region is displayed although the keyword is not marked. In document 1203, “after a period of 20 years from the filing date” in Article 67 (1) is marked. However, since the keyword “work” is included in Article 67 (2) of document 1203, paragraphs of Article 67 (1) and Article 67 (2) are displayed as the search results.

If this process is used for learning using the handwriting tablet terminal, the user can improve the learning efficiency since the documents related to the searched keyword are displayed as well as the documents including the marked keyword.

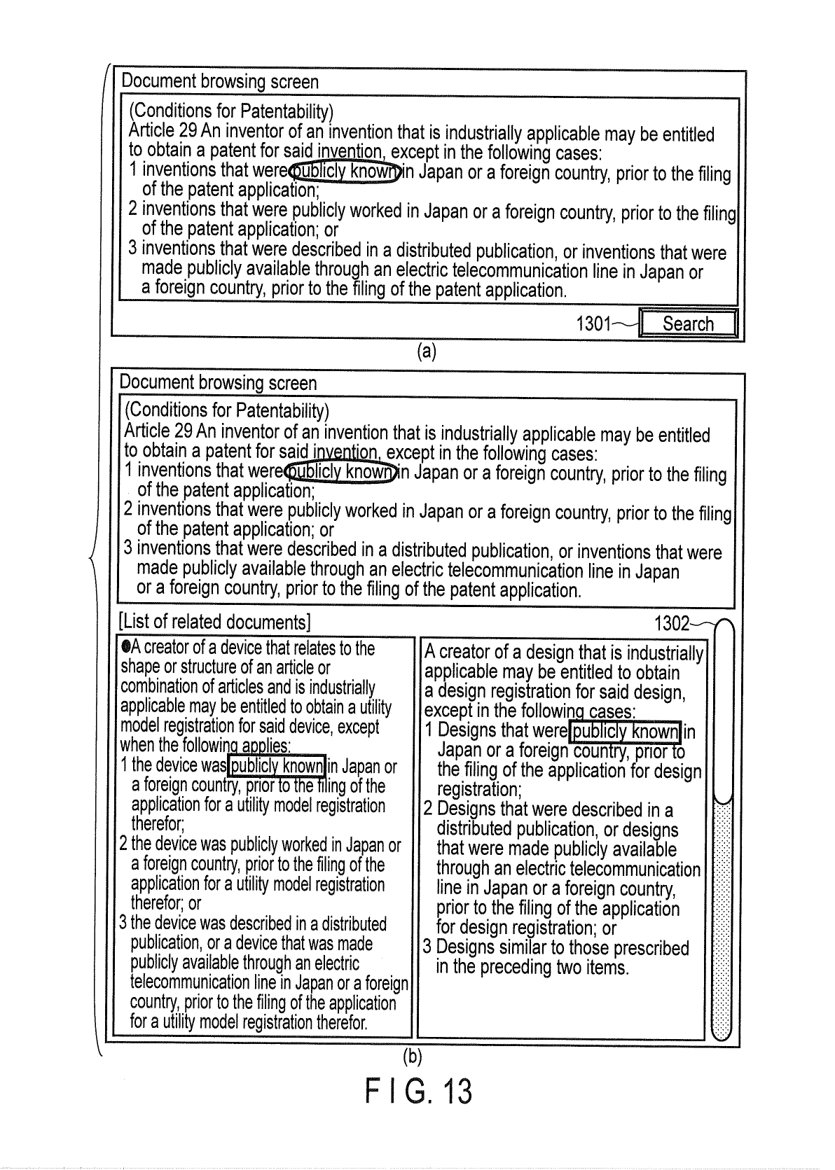

Next, an example of displaying the document relating to the browsing content will be explained with reference to FIG. 13.

In FIG. 13(a), the document in which the term “publicly known” is marked is displayed in the document browsing screen. If the user wishes to obtain information related to the displayed document, the user may press a related document searching button 1301. If the related document searching button 1301 is pressed, documents related to the displayed document are displayed as a list of related documents as shown in FIG. 13(b).

In the list, the document including the term “publicly known” marked in the displayed document is prioritized; however, the phrases related to an unmarked keyword in the displayed document may be displayed. For example, the documents related to the displayed document will be sequentially shown by scrolling a scroll bar 1302 at the right side of the list of related documents. Accordingly, the user of the tablet terminal including the target area estimation apparatus can improve the learning efficiency.

According to the target area estimation apparatus of the third embodiment, keywords are selectively displayed from the target areas marked by the user that the user is interested in, and the documents related to the target areas are displayed by searching for a keyword from the stored target areas, thereby widening the user's interest and improving the learning efficiency.

The flow charts of the embodiments illustrate methods and systems according to the embodiments. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A target area estimation apparatus, comprising:
a first acquisition unit configured to acquire a document formed of a plurality of elements;
a second acquisition unit configured to acquire sampling points of a stroke represented by coordinate values on a screen, by obtaining an input of the stroke to the document displayed on the screen;
a conversion unit configured to convert the sampling points into corresponding points each indicating a position in the document or at least one of the elements of the document including the position; and
an estimation unit configured to estimate a target area that a user is interested in, based on the corresponding points and the elements.

2. The apparatus according to claim 1, wherein the first acquisition unit acquires a structured document including the plurality of elements, and
the estimation unit estimates, as the target area, a block area in an element which includes the corresponding points, by acquiring the corresponding points by mapping the coordinate values of the sampling points to corresponding positions in the structured document.

3. The apparatus according to claim 1, wherein the second acquisition unit acquires stroke information in which the coordinate values are associated with times when the coordinate values are acquired, and
the estimation unit estimates, as the target area, a block area including a largest number of corresponding points included in an element if a time for inputting the stroke is short and a density of sampling points is less than a threshold, and estimates, as the target area, a string of characters in the element on a character basis if the time for inputting the stroke is long and the density of sampling points is not less than the threshold.

4. The apparatus according to claim 1, wherein the estimation unit extracts the target area and a displayed region which is part of the document displayed on the screen, the target area being accorded a higher priority than the displayed region.

5. The apparatus according to claim 1, further comprising:
a determination unit configured to determine whether a newly obtained stroke indicates expansion of the target area, deletion of part or all of the target area, or addition of another stroke; and
a modification unit configured to modify the target area if the newly obtained stroke indicates the expansion of the target area or the deletion of part or all of the target area.

6. The apparatus according to claim 1, further comprising an extraction unit configured to extract a keyword by performing morphological processing and proper expression extraction processing to a string of characters included in the target area.

7. The apparatus according to claim 6, further comprising a search unit configured to search for the keyword with a search word, the search word indicating a string of characters input by a user,
wherein the search unit sets a priority of the keyword to be presented to the user as highest if an extracted area in which a keyword matching with the search word is extracted is included in the target area, sets the priority to be second highest if the extracted area is included in a displayed region, and sets the priority to be third highest if the extracted area is included in an area other than the target area and the displayed region, the displayed region being part of the document displayed on the screen.

8. The apparatus according to claim 4, further comprising a storage configured to store elements of the document corresponding to the displayed region and elements of the document corresponding to the target area.

9. The apparatus according to claim 4, wherein elements of the document corresponding to the displayed region and elements of the document corresponding to the target area are stored in an external storage device.

10. A target area estimation method, comprising:
acquiring a document formed of a plurality of elements;
acquiring sampling points of a stroke represented by coordinate values on a screen by obtaining an input of the stroke to the document displayed on the screen;
converting the sampling points into corresponding points each indicating a position in the document or at least one of the elements of the document including the position; and
estimating a target area that a user is interested in, based on the corresponding points and the elements.

11. The method according to claim 10, wherein the acquiring the document acquires a structured document including the plurality of elements, and
the estimating the target area estimates, as the target area, a block area in an element which includes the corresponding points, by acquiring the corresponding points by mapping the coordinate values of the sampling points to corresponding positions in the structured document.

12. The method according to claim 10, wherein the acquiring the sampling points acquires stroke information in which the coordinate values are associated with times when the coordinate values are acquired, and
the estimating the target area estimates, as the target area, a block area including a largest number of corresponding points included in an element if a time for inputting the stroke is short and a density of sampling points is less than a threshold, and estimates, as the target area, a string of characters in the element on a character basis if the time for inputting the stroke is long and the density of sampling points is not less than the threshold.

13. The method according to claim 10, wherein the estimating the target area extracts the target area and a displayed region which is part of the document displayed on the screen, the target area being accorded a higher priority than the displayed region.

14. The method according to claim 10, further comprising:
determining whether a newly obtained stroke indicates expansion of the target area, deletion of part or all of the target area, or addition of another stroke; and
modifying the target area if the newly obtained stroke indicates the expansion of the target area or the deletion of part or all of the target area.

15. The method according to claim 10, further comprising extracting a keyword by performing morphological processing and proper expression extraction processing to a string of characters included in the target area.

16. The method according to claim 15, further comprising searching for the keyword with a search word, the search word indicating a string of characters input by a user,
wherein the searching for the keyword sets a priority of the keyword to be presented to the user as highest if an extracted area in which a keyword matching with the search word is extracted is included in the target area, sets the priority to be second highest if the extracted area is included in a displayed region, and sets the priority to be third highest if the extracted area is included in an area other than the target area and the displayed region, the displayed region being part of the document displayed on the screen.

17. The method according to claim 13, further comprising storing, in a storage, elements of the document corresponding to the displayed region and elements of the document corresponding to the target area.

18. The method according to claim 13, wherein elements of the document corresponding to the displayed region and elements of the document corresponding to the target area are stored in an external storage device.

19. A non-transitory computer readable medium including computer executable instructions, wherein the instructions, when executed by a processor, cause the processor to perform a method comprising:
acquiring a document formed of a plurality of elements;
acquiring sampling points of a stroke represented by coordinate values on a screen by obtaining an input of the stroke to the document displayed on the screen;
converting the sampling points into corresponding points each indicating a position in the document or at least one of the elements of the document including the position; and
estimating a target area that a user is interested in, based on the corresponding points and the elements.
